(19) United States
(12) Patent Application Publication
(10) Pub. No.: US 2011/0171338 A1
(43) Pub. Date: Jul. 14, 2011

(54) APPARATUS AND METHOD FOR MOLDING COMPOUND

(76) Inventors: DongChul Han, Cheonan-si (KR); Sanggeun Kim, Cheonan-si (KR); Kyoungrae Cho, Asan-si (KR); Dongsoo Lee, Cheonan-si (KR); Jongkak Jang, Asan-si (KR); Ho-Soo Jang, Asan-si (KR)

(21) Appl. No.: 12/948,179

(22) Filed: Nov. 17, 2010

(30) Foreign Application Priority Data
Jan. 8, 2010 (KR) 10-2010-0001890

(51) Int. Cl. B29C 45/24

(52) U.S. Cl. 425/226

(57) ABSTRACT

Provided are a device and method for molding a compound. The device for molding a compound may include a lower mold, an upper mold, and a cull degating unit. The lower mold may be configured to support a substrate and attach to a compound injector and the upper mold may be configured to cover the lower mold to form a space between the lower mold and the upper mold for receiving a compound from the compound injector. The cull degating unit may be in the upper mold and the cull degating unit may be configured to separate a cull of the compound in an injection passage from the compound molded on the substrate. The compound injector may be configured to inject a compound into the device such that a least a portion of the compound is molded on the substrate.

### CROSS-REFERENCE TO RELATED APPLICATIONS

This U.S. non-provisional patent application claims priority under 35 U.S.C. §119 to Korean Patent Application No. 10-2010-0001890, filed on Jan. 8, 2010, in the Korean Intellectual Property Office (KIPO), the entire contents of which are hereby incorporated by reference.

### BACKGROUND

1. Field

Example embodiments relate to an apparatus and method for molding a compound, and more particularly, to an apparatus and method for molding a compound on a printed circuit board.

2. Description of the Related Art

Generally, a semiconductor package comprises a printed circuit board on which a plurality of semiconductor chips is mounted. A compound may be molded on the semiconductor chips of the printed circuit board. Owing to the molded compound, wires bonded between the semiconductor chips and the printed circuit board may be protected, and influences of outside environments may be minimized. Such a molding compound may be molded into a predetermined semiconductor package shape by a compound molding apparatus.

During a compound molding process, a waste compound may remain in an injection passage. Such a waste compound is called a cull. After a molding process, such a cull is separated using an additional degating apparatus. This decreases the productivity of the molding process.

### SUMMARY

The present disclosure provides an apparatus and method for molding a compound. According to the apparatus and method, a cull generating in a compound molding process is removed in the compound molding process so that productivity can be increased or optimized.

The present disclosure also provides an apparatus and method for molding a compound through reduced processes for increasing or optimizing productivity.

In accordance with example embodiments, a device for molding a compound may include a lower mold configured to support a substrate and attached to a compound injector, an upper mold configured to cover the lower mold to faun a space between the lower mold and the upper mold for receiving the compound from the compound injector, and a cull degating unit in the upper mold, the cull degating unit configured to separate a cull of the compound in an injection passage from the compound molded on the substrate. In example embodiments, the compound injector may be configured to inject a compound into the device such that a least a portion of the compound is molded on the substrate.

In accordance with example embodiments, a method for molding a compound may include loading a substrate in a space between an upper mold and a lower mold, enclosing the substrate with the upper mold and the lower mold, and molding a compound on the substrate, separating a cull of the compound remaining around the substrate from the compound molded on the substrate by using a cull degating unit, and removing the cull from the upper mold and the lower mold, and unloading the substrate.

In accordance with example embodiments an apparatus for molding a compound, may include a lower mold configured to support a substrate, an upper mold configured to cover the lower mold and to form a space on the substrate opposite to the lower mold, a compound injector configured to inject a compound into the space between the upper mold and the substrate for molding the compound on the substrate, and a cull degating unit configured to separate a cull of the compound remaining in an injection passage from the compound injector to the substrate from the compound molded on the substrate.

In example embodiments, the cull degating unit may comprise at least one of a cull degating pin and a cull degating knife configured to separate the cull from the compound molded on the substrate.

In example embodiments, the cull degating pin or the cull degating knife may comprise one of wedge tip, a flat tip, and a complex tip configured to cut the cull.

In example embodiments, the cull degating unit may further comprise a first upper plate configured to lift and lower the cull degating pin or the cull degating knife, and the first upper plate may be configured to be lifted and lowered inside the upper mold.

In example embodiments, the cull degating unit may further comprise a cull lift pin configured to lift the cull in a direction facing the cull degating pin or the cull degating knife.

In example embodiments, the cull degating unit may further comprise a first lower plate configured to lift and lower the cull lift pin, and the first lower plate may be configured to be lifted and lower inside the lower mold.

In example embodiments, the upper mold may comprise at least one penetration hole to fix the cull. The penetration hole may receive a protrusion of the cull, and a jaw may be disposed on a side of the protrusion for fixing the protrusion to the penetration hole. The jaw may have a reverse-tapered shape toward an upper side of the protrusion.

In example embodiments, the apparatus may further comprise a cull discharge pin configured to discharge the cull from the penetration hole.

In example embodiments, the apparatus may further comprise a second upper plate configured to lift and lower the cull discharge pin, and the second upper plate may be lifted and lowered inside the upper mold.

In example embodiments, the apparatus may further comprise at least one substrate lift pin configured to lift the substrate upward from the lower mold, and the apparatus may further comprise a second lower plate configured to lift and lower the substrate lift pin. The second lower plate may be configured to be lifted and lowered inside the lower mold.

Example embodiments provide methods for molding a compound, the methods may include loading a substrate in a space between an upper mold and a lower mold, enclosing the substrate with the upper mold and the lower mold, and molding a compound on the substrate, separating a cull of the compound remaining around the substrate from the compound molded on the substrate by using a cull degating unit, and removing the cull from the upper mold and the lower mold, and unloading the substrate.

In example embodiments, the cull degating unit may separate the cull from the substrate or the compound when the upper mold and the lower mold are separated.

In example embodiments, the substrate or the compound molded on the substrate may be lowered by a substrate lowering pin, a compound lowering pin, or a cull degating knife connected to a first upper plate disposed in the upper mold, and the cull may be supported by a cull lift pin connected to a first lower plate disposed in the lower mold. The cull may be separated from the upper mold by lowering a cull discharge pin through a penetration hole formed in the upper mold, and then, the cull may be removed.

### BRIEF DESCRIPTION OF THE DRAWINGS

The accompanying drawings provide an understanding of example embodiments, and are incorporated in and constitute a part of this specification. The drawings illustrate example embodiments and, together with the description, serve to explain principles of the inventive concepts. In the drawings:

FIGS. 1 and 2 are a plan view and a sectional view illustrating an apparatus for molding a compound according to example embodiments;

FIGS. 3 and 4 are detailed sectional views illustrating source culls, dummy culls, and a cull degating unit of FIGS. 1 and 2;

FIGS. 5A through 5F are views illustrating source cull degating pins;

FIGS. 6A and 6B are sectional views illustrating a cull and an upper block;

FIGS. 7A through 7C are plan views each illustrating a reverse-tapered part of a cull; and

FIGS. 8 through 13 are sequential sectional views for explaining a method of molding a compound according to example embodiments.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments will be described below in more detail with reference to the accompanying drawings. Example embodiments may, however, be embodied in different forms and should not be construed as limited to the embodiments set forth herein. Rather, example embodiments are provided so that this disclosure will be thorough and complete, and will fully convey the scope of the inventive concepts to those skilled in the art. In the drawings, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

Example embodiments will be described below in more detail with reference to the accompanying drawings. Example embodiments may, however, be embodied in different forms and should not be construed as limited to the embodiments set forth herein. Rather, example embodiments are provided so that this disclosure will be thorough and complete, and will fully convey the scope of the inventive concepts to those skilled in the art.

It will also be understood that when a block or plate is referred to as being ‘on’ another block or plate, it can be directly on the other block or plate, or intervening blocks or plate may also be present. Further, it will be understood that when a block or plate is referred to as being ‘under’ another block or plate, it can be directly under, and one or more intervening block or plate may also be present. In the drawings, the dimensions of blocks or plates are exaggerated for clarity of illustration. In addition, it will be understood that although the terms first and second are used herein to describe various plates and pins, these plates and pins should not be limited by these terms. An embodiment described and exemplified herein comprises a complementary embodiment thereof.

Hereinafter, example embodiments will be described in detail with reference to the accompanying drawings.

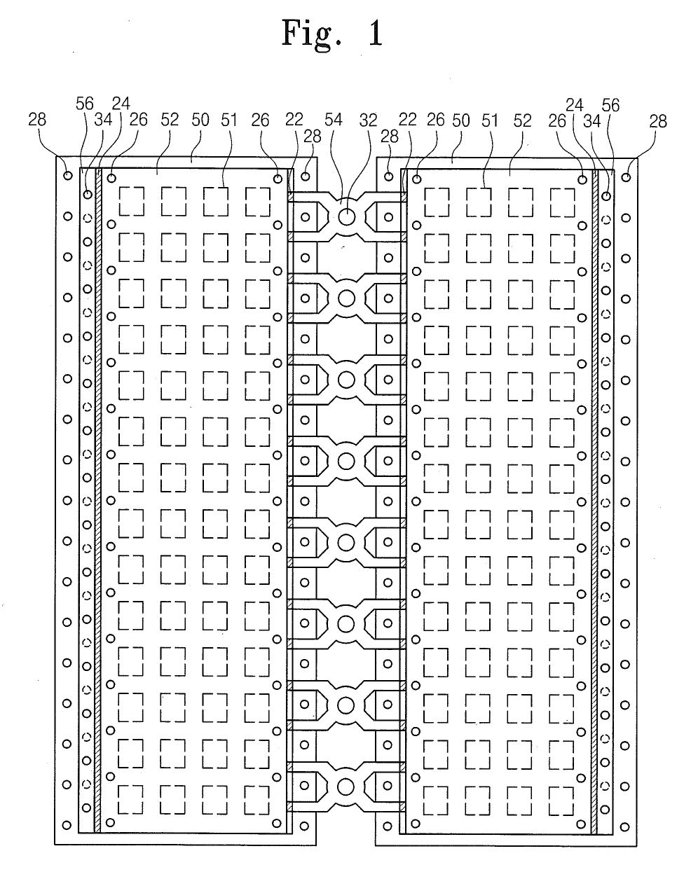

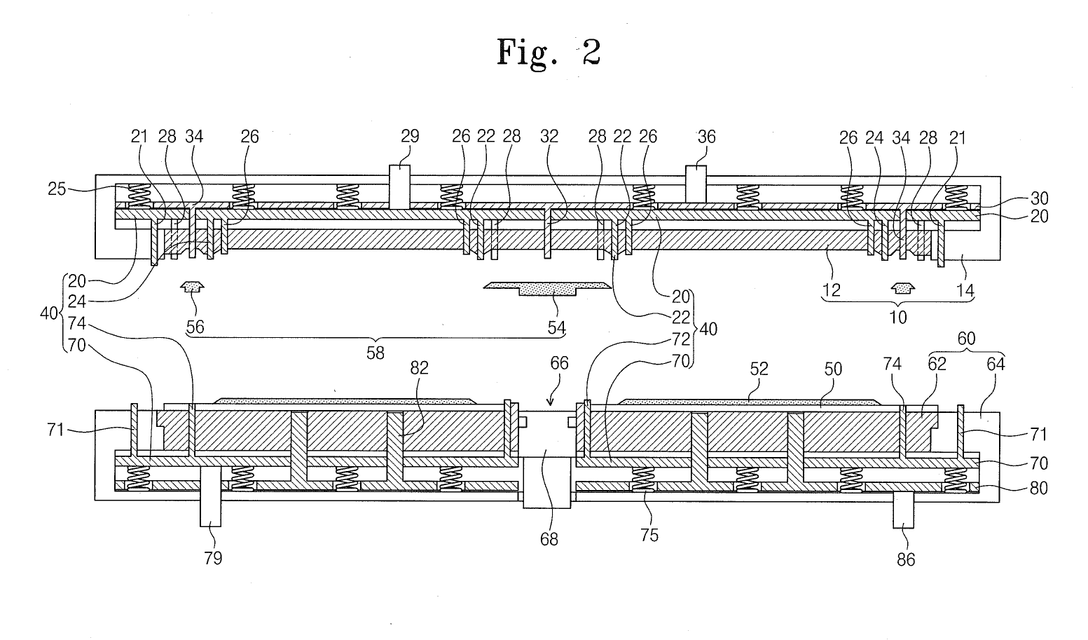

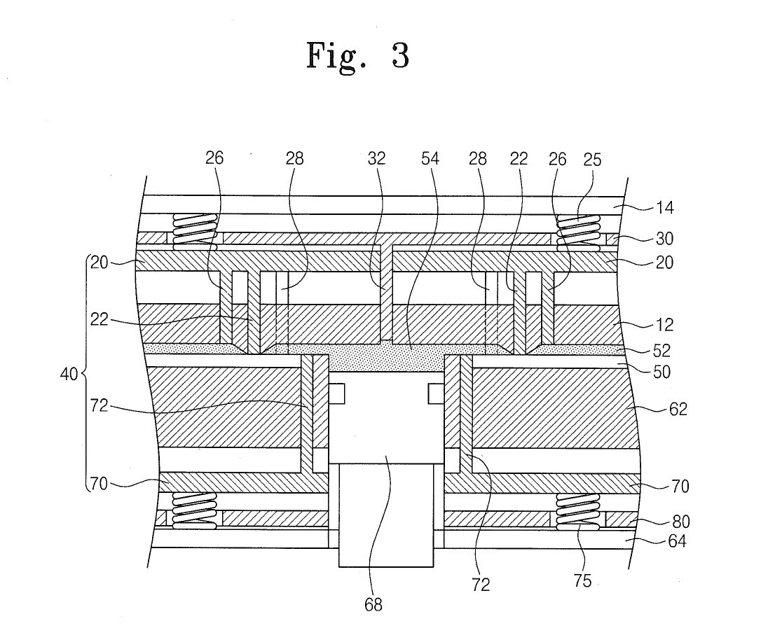

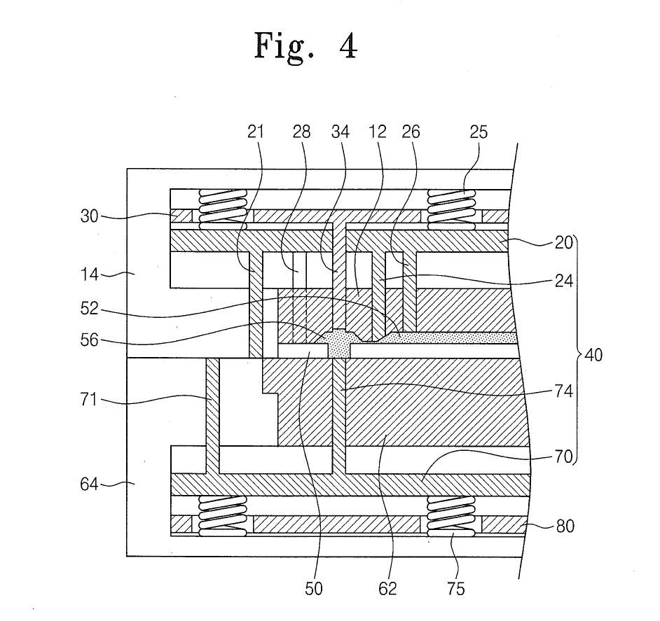

FIGS. 1 and 2 are a plan view and a sectional view illustrating an apparatus for molding a compound according to example embodiments, and FIGS. 3 and 4 are detailed sectional views illustrating source culls, dummy culls, and a cull degating unit as illustrated in FIGS. 1 and 2. FIG. 1 illustrates substrates loaded in the compound molding apparatus and a compound disposed on the substrates.

Referring to FIGS. 1 through 4, in the compound molding apparatus, a compound 52 may be molded on a plurality of substrates 50 loaded between an upper mold 10 and a lower mold 60. In addition, culls 58 formed on the peripheries of the substrates 50 while the compound 52 is molded may be removed. The substrates 50 may comprise printed circuit boards (PCBs) or lead frames on which a plurality of semiconductor chips 51 are mounted. The compound 52 may be molded on the semiconductor chips 51 mounted on the substrates 50. The culls 58 may comprise source culls 54 and dummy culls 56. The source culls 54 may be a waste compound remaining from a compound injection inlet 66 through which the compound 52 is injected to the substrates 50. The dummy culls 56 may be a surplus waste compound protruding from edges of the substrates 50 opposite to the source cull 54.

The source culls 54 and the dummy culls 56 may be separated from the compound 52 disposed on the substrates 50 by using a cull degating unit 40. For example, the cull degating unit 40 may comprise source cull degating pins 22 and source cull lift pins 72 for removing the source culls 54, and dummy cull degating knifes 24 and dummy cull lift pins 74 for removing the dummy culls 56. The source cull degating pins 22 and the source cull lift pins 72 may be moved in opposite directions to remove the source culls 54 from the compound 52 disposed on the substrates 50. Similarly, the dummy cull degating knifes 24 and the dummy cull lift pins 74 may be moved in opposite directions to remove the dummy culls 56 from the compound 52 disposed on the substrates 50. The source cull degating pins 22 and the dummy cull degating knifes 24 may be connected to a first upper plate 20. The source cull lift pins 72 and the dummy cull lift pins 74 may be connected to a first plate 70.

In this way, the example compound molding apparatus illustrated in FIGS. 1-4 may form the compound 52 on the substrates 50 and remove the culls 58 formed at the peripheries of the substrates 50.

The upper mold 10 may comprise an upper housing 14 and an upper block 12. The upper block 12 may form a space or cavity above the substrates 50 and may be spaced a predetermined distance from the substrates 50. The compound 52 may be injected in the space. The upper housing 14 may cover the upper side of the upper block 12. The first upper plate 20 and a second upper plate 30 may be disposed between the upper housing 14 and the upper block 12. The first upper plate 20 and the second upper plate 30 may be connected to a first upper shaft 29 and a second upper shaft 36, respectively.

The first upper plate 20 may include or support the upper return pins 21, the source cull degating pins 22, the dummy cull degating knifes 24, compound lowering pins 26, and substrate lowering pins 28. The source cull degating pins 22, the dummy cull degating knifes 24, the compound lowering pins 26, and the substrate lowering pins 28 may penetrate the upper block 12. The first upper plate 20 may be supported by the upper housing 14 through upper springs 25. The second upper plate 30 may include or support source cull discharge pins 32 and dummy cull discharge pins 34. In example embodiments, the source cull discharge pins 32 and the dummy cull discharge pins 34 may penetrate the first upper plate 20 and the upper block 12 for discharging the source culls 54 and the dummy culls 56.

The lower mold 60 may comprise a lower housing 64 and a lower block 62. The lower block 62 may support the substrates 50 evenly. The lower housing 64 may cover the lower side of the lower block 62. A first lower plate 70 and a second lower plate 80 may be disposed between the lower housing 64 and the lower block 62. The first lower plate 70 and the second lower plate 80 may be connected to a first lower shaft 79 and a second lower shaft 86, respectively. The first lower plate 70 may include or support source cull lift pins 72, dummy cull lift pins 74, and lower return pins 71 that may penetrate the lower block 62 and the lower housing 64. The first lower plate 70 may be supported by the lower housing 64 through lower springs 75. The second lower plate 80 may connect substrate lift pins 82 that lift the substrates 50 upward.

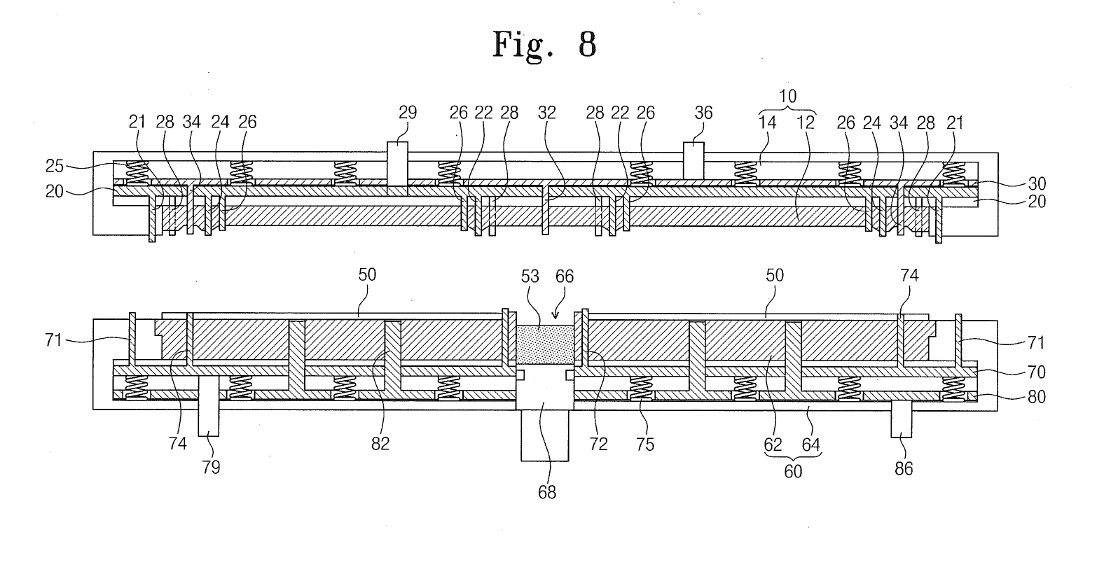

The lower mold 60 may comprise the compound injection inlet 66 through which the compound 52 may be injected between the substrates 50. The compound 52 may be injected into a space formed among the substrates 50 and the upper mold 10 by operation of a ram 68 that reciprocates vertically. A heater (not shown) may be disposed at the compound injection inlet 66 to heat the compound 52 to about 160° C. or higher. The ram 68 may be a compound injector configured to inject a compound source 53 (refer to FIG. 8) between the upper mold 10 and the lower mold 60. The compound source 53 may comprise epoxy molding compound (EMC).

As described above, the first upper plate 20 and the first lower plate 70 may be moved in opposite directions to separate the source culls 54 and the dummy culls 56 from the substrates 50 or the compound 52 disposed on the substrates 50. If the first upper plate 20 is moved downward, the substrates 50 and the compound 52 disposed on the substrates 50 may be lowered by the compound lowering pins 26 and the substrate lowering pins 28. On the other hand, if the first lower plate 70 is lifted, the source culls 54 and the dummy culls 56 may be lifted by the source cull lift pins 72 and the dummy cull lift pins 74, respectively. Therefore, the source culls 54 and the dummy culls 56 can be separated from the substrates 50 and the compound 52 disposed on the substrates 50. Lifting and lowering ranges of the first upper plate 20 and the first lower plate 70 may be determined or controlled by the upper return pins 21 and the lower return pins 71, respectively.

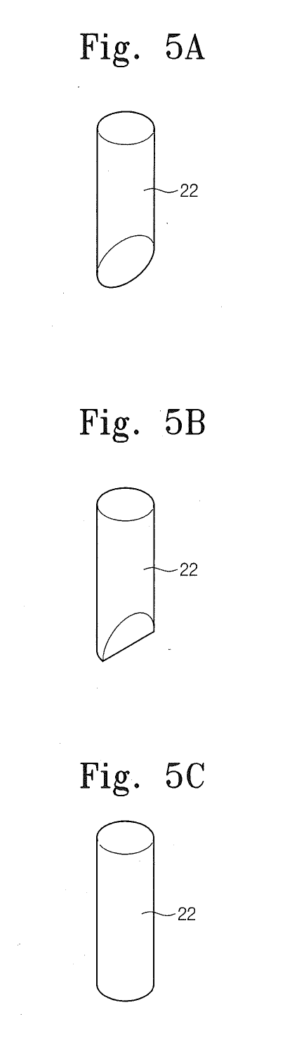

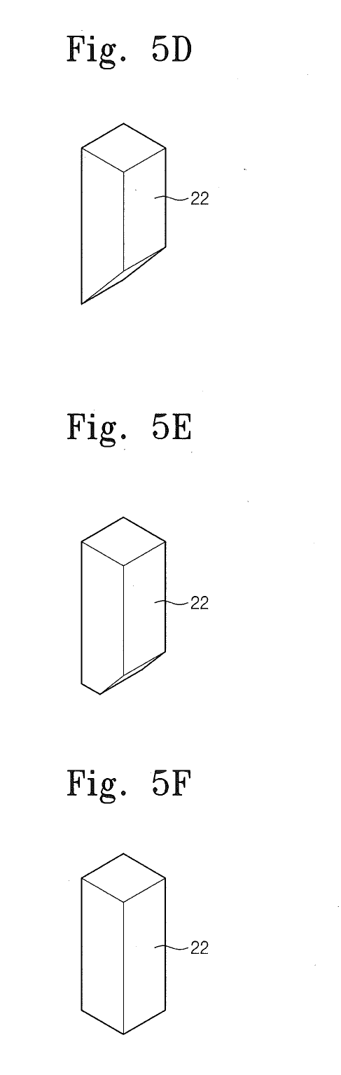

The source cull degating pins 22 and the dummy cull degating knifes 24 may define perforated lines for separating the source culls 54 and the dummy culls 56 from the compound 52 molded on the substrates 50. According to the contact surfaces of the source cull degating pins 22 and the dummy cull degating knifes 24 with the source culls 54 or the dummy culls 56, the source cull degating pins 22 and the dummy cull degating knifes 24 may have various shapes. For example, an end part of the source cull degating pin 22 may have various shapes as shown in FIGS. 5A to 5F.

FIGS. 5A through 5F are views illustrating example shapes of the source cull degating pin 22. The source cull degating pin 22 may have a cylindrical or square bar shape with a wedge, flat, or complex tip. When the source cull degating pin 22 has a wedge tip (see FIGS. 5A and 5D), the contact surface between the source cull degating pin 22 and the source cull 54 can be minimized so that the source cull degating pin 22 can approach the compound 52 disposed on the substrate 50 more closely and separate the source cull 54 from the compound 52. When the source cull degating pin 22 has a flat tip (see FIGS. 5C and 5F), the contact surface between the source cull degating pin 22 and the source cull 54 can be maximized. When the source cull degating pin 22 has a complex tip (see FIGS. 5B and 5E), the contact surface between the source cull degating pin 22 and the source cull 54 may be medium as compared with the cases where the source cull degating pin 22 has a wedge tip and a flat tip. Therefore, according to the area of a connection part between the source cull 54 and the compound 52 disposed on the substrate 50, the source cull degating pin 22 may have a wedge, flat, or complex tip. Although not shown, the dummy cull degating knife 24 may also have a wedge, flat, or complex tip.

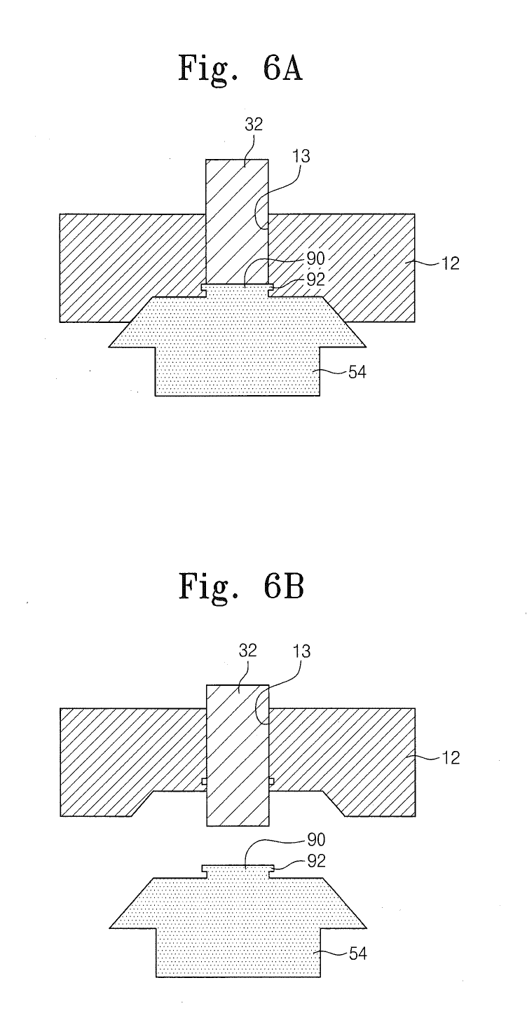

The second upper plate 30 may be lowered to separate the source culls 54 and the dummy culls 56 from the upper block 12 after the source culls 54 and the dummy culls 56 are separated from the compound 52 disposed on the substrates 50. The source cull discharge pins 32 and the dummy cull discharge pins 34 may push the source culls 54 and the dummy culls 56 downward from the upper block 12, respectively. For example, the source cull 54 may stick to the upper block 12 as shown in FIG. 6A, and then the source cull 54 may be separated from the upper block 12 as shown in FIG. 6B.

FIGS. 6A and 6B are sectional views illustrating the source cull 54 and the upper block 12. Owing to a source protrusion 90 inserted in a penetration hole 13 of the upper block 12, the source cull 54 may be fixed to the upper block 12. In example embodiments, the source cull 54 may be separated from the upper block 12 if the source cull discharge pin 32 is lowered. The source protrusion 90 may comprise a source jaw 92 which is reverse-tapered toward the top side of the source cull 54. Owing to the source jaw 92, the source protrusion 90 may be fixed to the penetration hole 13 of the upper block 12. The source protrusion 90 and the source jaw 92 may be released from the penetration hole 13 when the source cull discharge pin 32 is lowered.

The dummy cull 56 may comprise a dummy protrusion (not shown) configured to be fixed to the upper block 12. The dummy protrusion may also comprise a dummy jaw reverse-tapered toward the top side of the dummy cull 56.

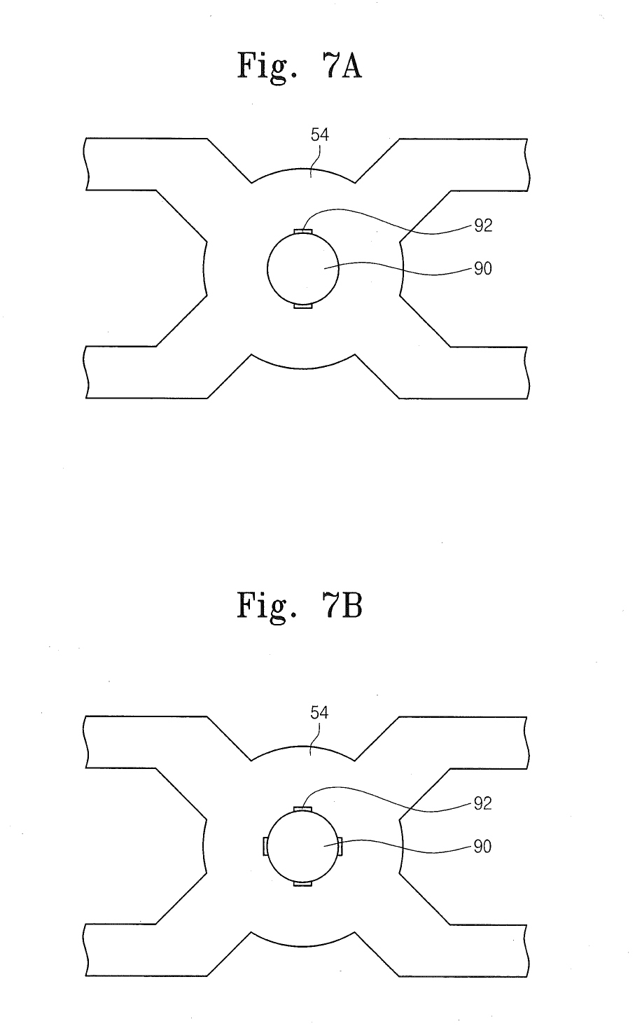

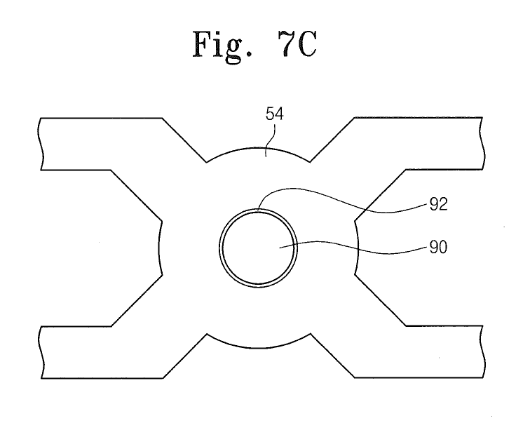

FIGS. 7A through 7C are plan views illustrating exemplary reverse-tapered source jaws 92 that may be formed on the source protrusion 90 of the source cull 54. The source jaw 92 may be disposed at two or four positions around the source protrusion 90 or all around the source protrusion 90. For example, the source jaw 92 may comprise hooks or latches at two or four positions of the source protrusion 90 that extend from the source protrusion 90 in radial directions. Although the source jaw 92 may comprise a ring disposed all around the source protrusion 90, example embodiments are not limited thereto as the source jaw 92 may include a ring which only partially circumscribes the source protrusion 90. In addition, although not shown, the dummy jaw of the dummy protrusion may have shape similar to the shape of the source jaw 92.

The source culls 54 and the dummy culls 56 may be discharged using a waste plate (not shown) loaded between the upper mold 10 and the lower mold 60. That is, in the compound molding apparatus of example embodiments, the source culls 54 and the dummy culls 56 stuck to the upper block 12 may be separated from the compound 52 disposed on the substrates 50, and then the source culls 54 and the dummy culls 56 may be separated from the upper block 12 and be discharged.

The substrates 50 on which the compound 52 is disposed may be lifted from the lower block 62 by lifting the second lower plate 80. When the substrates 50 are lifted by the second lower plate 80, the substrate lift pins 82 may push the substrates 50 upward. The substrates 50 may be unloaded from the substrate lift pins 82 by an unloading arm that can be moved to and away from the upper side of the lower mold 60. In addition, the next substrates 50 may be loaded on the substrate lift pins 82 by a loading arm.

A method of molding a compound using the above-described compound molding apparatus will now be described according to example embodiments.

FIGS. 8 through 13 are sequential sectional views for explaining a method of molding a compound according to example embodiments.

Referring to FIG. 8, a plurality of substrates 50 may be loaded on the lower mold 60. The plurality of substrates 50 may be loaded on the lower mold 60 by a loading arm. The loading arm may be moved into and away from a region between the lower mold 60 and the upper mold 10. In example embodiments, the lower mold 60 and the upper mold 10 may be spaced a predetermined distance from each other. The loading arm may load the substrates 50 on the substrate lift pins 82 that may protrude through the lower block 62, and then, the loading arm may return to the outside. In a state where the substrates 50 are supported on the substrate lift pins 82, the substrates 50 may be placed on the lower block 62. For example, the substrate lift pins 82 may support the substrates 50 in a state where the second lower plate 80 is lifted to the highest position in the lower mold 60. When the second lower plate 80 is lowered, the substrates 50 may be placed from the substrate lift pins 82 to the lower block 62. The substrates 50 may be placed on the lower block 62 in a manner such that the substrates 50 are symmetric with respect to the compound injection inlet 66. The substrates 50 may comprise a printed circuit board or lead frame on which a plurality of semiconductor chips are mounted.

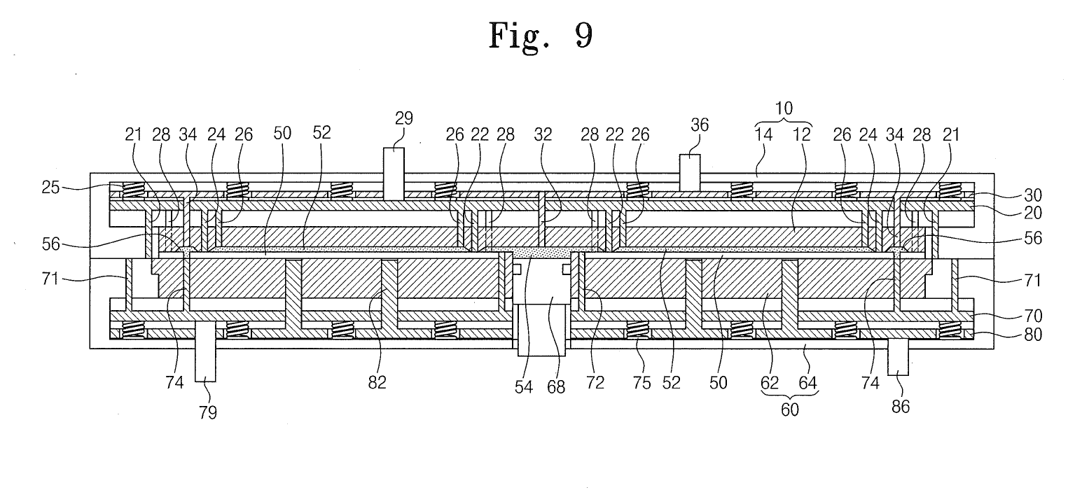

Referring to FIG. 9. a compound source 53 may be injected between the lower mold 60 and the upper mold 10 to mold a compound 52 on the substrates 50. The lower mold 60 may be lifted to couple with the upper mold 10 or approach the upper mold 10. The upper mold 10 and the lower mold 60 may provide a sealed state for the substrates 50. The upper mold 10 may form a space through which the compound 52 may be molded on the substrates 50. That is, the compound source 53 may be injected in the space formed by the upper mold 10. The compound source 53 may be injected through the compound injection inlet 66 disposed between the substrates 50 and the ram 68. The ram 68 may press the compound source 53 against the upper block 12 so that the compound source 53 can be filled to both sides of the substrates 50 in the space formed by the upper mold 10. The compound source 53 may be heated to a high temperature of about 160° C. The compound source 53 may be filled in the space in a highly flowable liquid state. In addition, the compound source 53 may fill in holes through which the source cull discharge pins 32 and the dummy cull discharge pins 34 are moved. The compound 52 may be formed by natural cooling inside the upper mold 10 and the lower mold 60. The compound 52 may be molded on the substrates 50. The compound 52 may comprise source culls 54 remaining the upper side of the ram 68 to the substrates 50 disposed at both sides of the ram 68, and dummy culls 56 remaining at the peripheries of the substrates 50 opposite to the ram 68. Each of the source culls 54 and the dummy culls 56 may comprise a jaw formed at a penetration hole of the upper block 12. The source culls 54 and the dummy culls 56 may stick to the upper block 12.

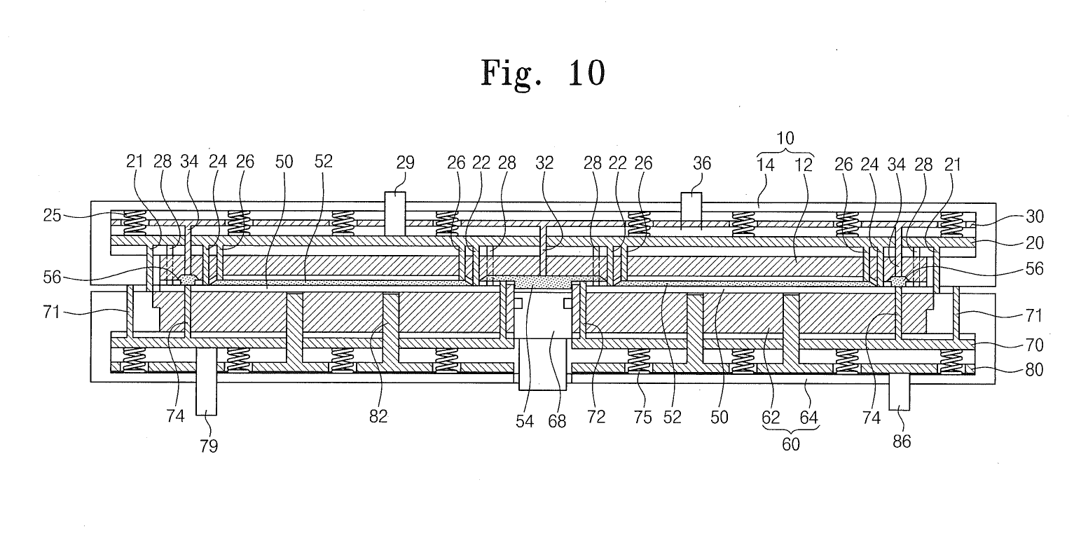

Referring to FIG. 10, the source culls 54 and the dummy culls 56 are separated from the compound 52 disposed on the substrates 50. The source culls 54 and the dummy culls 56 may be separated from the substrates 50 when the upper mold 10 and the lower mold 60 are separated from each other. For example, the source culls 54 and the dummy culls 56 may be separated from the compound 52 disposed on the substrates 50 when the first upper plate 20 and the first lower plate 70 are lifted and lowered. The upper mold 10 and the first upper plate 20 may be moved in opposite directions. In addition, the lower mold 60 and the first lower plate 70 may be moved in opposite directions. In detail, the substrates 50 or the compound 52 disposed on the substrates 50 may be lowered by the substrate lowering pins 28, the compound lowering pins 26, and the dummy cull degating knifes 24 connected to the first upper plate 20. On the other hand, the source culls 54 and the dummy culls 56 may be supported by the source cull lift pins 72 and the dummy cull lift pins 74 connected to the first lower plate 70. The source cull degating pins 22 and the dummy cull degating knifes 24 may separate the source culls 54 and the dummy culls 56 from the substrates 50 when the first upper plate 20 is lowered. The source cull lift pins 72 and the dummy cull lift pins 74 may push the source culls 54 and the dummy culls 56 upward to the upper block 12.

Therefore, according to the compound molding method of example embodiments, when the upper mold 10 and the lower mold 60 are separated after the compound 52 is molded, the source culls 54 and the dummy culls 56 can be separated from the substrates 50.

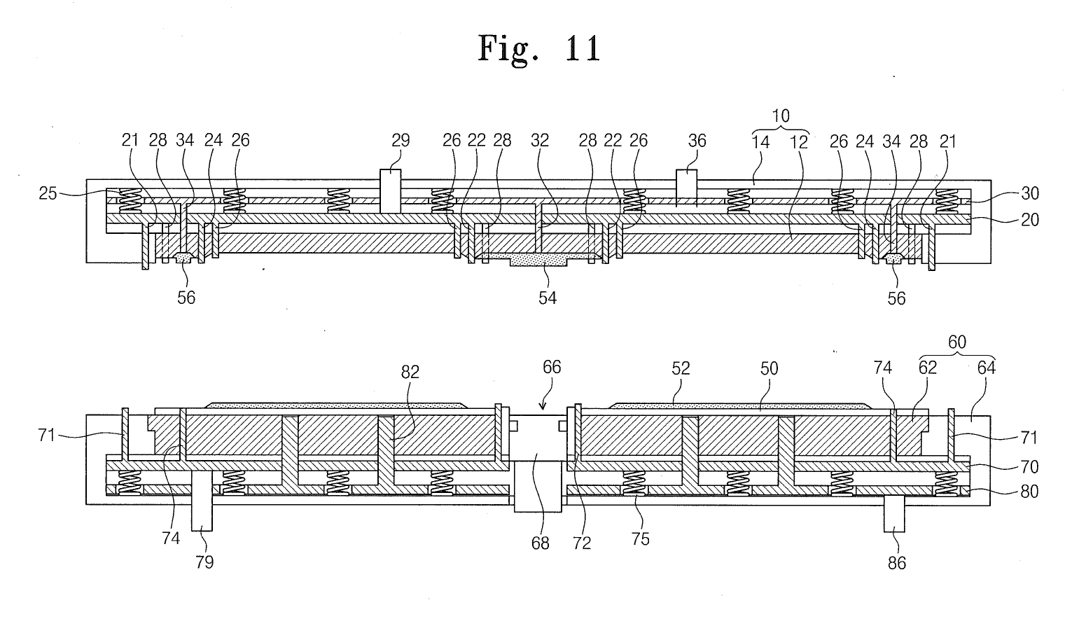

Referring to FIG. 11, the lower mold 60 may be lowered to the lowest position. Then, the upper mold 10 and the lower mold 60 may be spaced as much as possible. At this time, the first lower plate 70 and the second lower plate 80 disposed inside the lower mold 60 may be lowered together with the lower mold 60. A waste plate may be moved between the upper mold 10 and the lower mold 60.

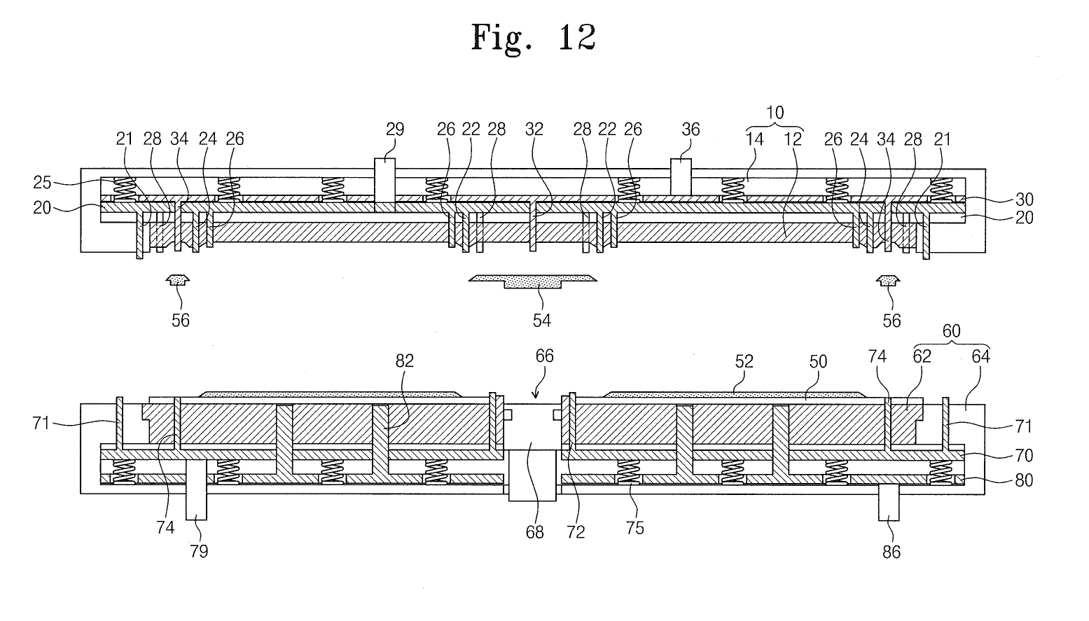

Referring to FIG. 12, the second upper plate 30 may be lowered to remove the source culls 54 and the dummy culls 56. The second upper plate 30 may be lowered to separate the source culls 54 and the dummy culls 56 from the upper block 12. The source culls 54 and the dummy culls 56 fixed to penetration holes of the upper block 12 may be discharged by the source cull discharge pins 32 and the dummy cull discharge pins 34. The source culls 54 and the dummy culls 56 may fall on the waste plate placed between the upper mold 10 and the lower mold 60, and then the source culls 54 and the dummy culls 56 may be removed.

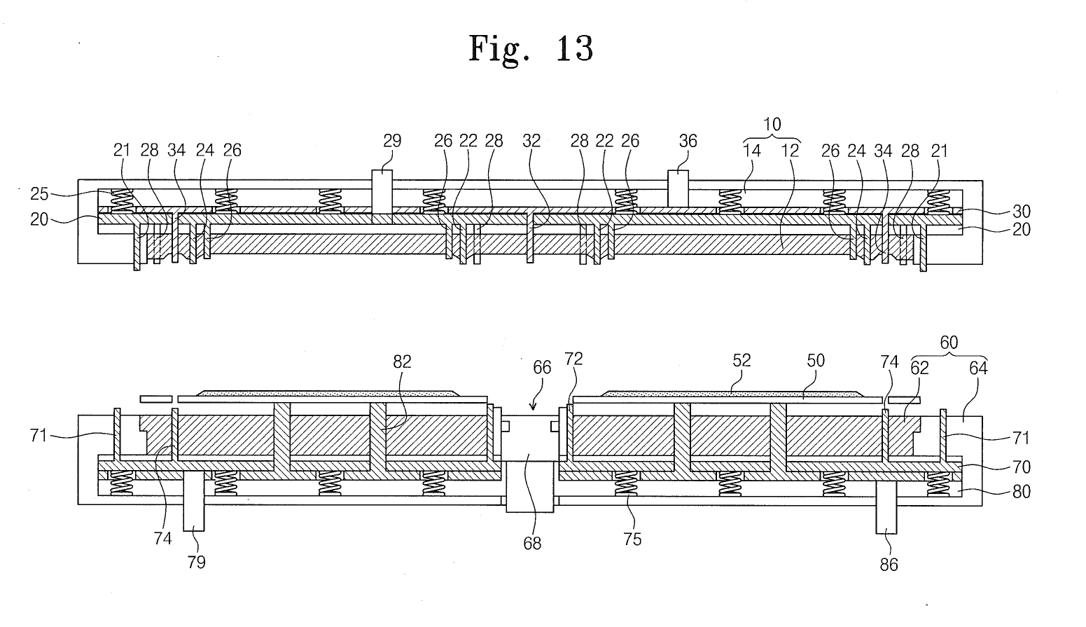

Referring to FIG. 13, the substrates 50 may be lifted from the lower mold 60 and be unloaded. The substrates 50 may be lifted by the second lower plate 80 and the substrate lift pins 82. Thereafter, the substrates 50 may be unloaded to the outside of the upper mold 10 and the lower mold 60 by an unloading arm.

Therefore, according to the compound molding method of example embodiments, the source culls 54 and the dummy culls 56 remaining on the peripheries of the compound 52 after the compound 52 is molded on the substrates 50 may be removed, and thus productivity may be increased or optimized.

According to example embodiments, culls may be removed using the cull degating unit disposed in the upper and lower molds by which a molding process is performed. Therefore, productivity may be increased or optimized.

In addition, since culls may be removed from a plurality of substrates a compound molded on the substrates when the upper and lower molds are separated, productivity may be increased or optimized.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

1. A device for molding a compound, the device comprising:
a lower mold configured to support a substrate and attached to a compound injector, the compound injector being configured to inject a compound into the device such that a least a portion of the compound is molded on the substrate;
an upper mold configured to cover the lower mold to form a space between the lower mold and the upper mold for receiving the compound from the compound injector; and
a cull degating unit in the upper mold and the lower mold, the cull degating unit configured to separate a cull of the compound in an injection passage from the compound molded on the substrate.

2. The device of claim 1, wherein the cull degating unit includes at least one of a cull degating pin and a cull degating knife configured to separate the cull from the compound molded on the substrate.

3. The device of claim 2, wherein the at least one of the cull degating pin and the cull degating knife comprises one of wedge tip, a flat tip, and a complex tip configured to cut the cull.

4. The device of claim 2, wherein the cull degating unit further includes a first upper plate configured to lift and lower the at least one of the cull degating pin and the cull degating knife.

5. The device of claim 4, wherein the first upper plate is configured to be lifted and lowered inside the upper mold.

6. The device of claim 2, wherein the cull degating unit further includes a cull lift pin configured to lift the cull in a direction facing the at least one of the cull degating pin and the cull degating knife.

7. The device of claim 6, wherein the cull degating unit further comprises a first lower plate configured to lift and lower the cull lift pin.

8. The device of claim 7, wherein the first lower plate is configured to be lifted and lowered inside the lower mold.

9. The device of claim 1, wherein the upper mold includes at least one penetration hole to fix the cull.

10. The device of claim 9, wherein the penetration hole is configured to receive a protrusion of the cull, the protrusion including a jaw on a side of the protrusion for fixing the protrusion to the penetration hole.

11. The device of claim 10, wherein the jaw has a reverse-tapered shape toward an upper side of the protrusion.

12. The device of claim 9, further comprising:
a cull discharge pin configured to discharge the cull from the penetration hole.

13. The device of claim 12, further comprising:
a second upper plate configured to lift and lower the cull discharge pin.

14. The device of claim 1, further comprising:
at least one substrate lift pin configured to lift the substrate upward from the lower mold.

15. The device of claim 14, further comprising:
a second lower plate configured to lift and lower the substrate lift pin in the lower mold.

16.-19. (canceled)

20. An apparatus for molding a substrate, the apparatus comprising:
the device of claim 1; and
compound injector configured to inject the compound into the device.
